(19) United States
(12) Patent Application Publication
(10) Pub. No.: US 2015/0301328 A1
(43) Pub. Date: Oct. 22, 2015

(54) SYSTEM AND METHOD OF ACQUIRING IMAGES WITH A ROLLING SHUTTER CAMERA WHILE ASYNCHRONOUSLY SEQUENCING MICROSCOPE DEVICES

(71) Applicant: MOLECULAR DEVICES, LLC, Sunnyvale, CA (US)

(72) Inventors: Bruce Gonzaga, Coatesville, PA (US); William Peterson, West Chester, PA (US)

(21) Appl. No.: 14/442,942

(22) PCT Filed: Nov. 15, 2013
(86) PCT No.: PCT/US2013/070425

§ 371 Date: May 14, 2015

Related U.S. Application Data
(60) Provisional application No. 61/727,374, filed on Nov. 16, 2012.

(51) Int. Cl. G02B 21/36

(52) U.S. Cl. CPC G02B 21/365

(57) ABSTRACT

A computer-implemented method and an image acquisition system for synchronizing movement of a device associated with a microscope and acquisition of images from a camera associated with the microscope. An exposure signal is received from the camera associated with the microscope. The exposure signal is analyzed to identify a period of time when the device associated with the microscope may be moved. In addition, image data associated with the exposure signal is received. Further a command is issued to the device associated with the microscope to move the device associated with the microscope to a new position during the identified period of time.

### RELATED APPLICATION

This application claims the benefit of U.S. Provisional Patent Application Ser. No. 61/727,374, filed Nov. 12, 2012, the content of which is incorporated by reference herein in its entirety.

### TECHNICAL FIELD

The present invention relates generally to acquiring images from an optical microscope system, and more particularly to acquiring images with a rolling shutter camera while asynchronously sequencing components of such microscope devices.

### BACKGROUND

An automated microscope system may be controlled by an image acquisition system to capture images of one or more samples disposed on an X-Y stage of such microscope. In addition to the stage, the microscope may include other devices such as a camera mount, a camera disposed in such mount, a flash unit, a lens system, and the like. Such devices may be moved under control of the image acquisition system so that the camera may capture images of different portions of a sample, of different samples, at different focus planes, and/or using different lighting conditions. The microscope devices may also include optical elements including filters, phase rings, dichromatic mirrors, and bandpass filters. The position of such microscope devices may be modified between frames of the sample capture by the automated microscope during the course of an experiment.

Typically, a sensor used in a digital camera comprises lines of pixel elements arranged in a two-dimensional pattern. Some cameras suitable for use with the automated microscope use a global shutter. In such cameras, all of the pixels of the camera sensor are simultaneously exposed to light reflected from, emitted by, and/or transmitted through the sample for a predetermined exposure time. At the end of the exposure time, data from all of the pixels of the sensor are read and transmitted to the image acquisition system as an image frame.

Other cameras, in particular cameras that use CMOS sensors, use a rolling shutter. Typically, such shutters begin exposure of each row (or line) of pixels of the camera sensor at a different time. In these cameras, there is a period of time during which all or a group of the lines of pixels are simultaneously exposed. Further, some cameras that use a rolling shutter can read and transmit data from the lines of pixels while such pixels are being exposed.

When used in an automated microscope system, movement of the microscope devices must be coordinated with acquisition of an image from the camera to avoid artifacts in the acquired image. For example, global image blur may appear in an image captured using a global shutter if the position of the sample relative to the camera changes during the exposure time. Images captured with a rolling shutter during such movement may show horizontal and/or vertical shifts in portions of an image or illumination differences in different portions of the captured image.

### SUMMARY

A computer-implemented method of synchronizing movement of a device associated with a microscope and acquisition of images from a camera associated with the microscope. The computer-implemented method receives an exposure signal from the camera associated with the microscope. The exposure signal is analyzed to identify a period of time when the device associated with the microscope may be moved. In addition, image data associated with the exposure signal is received. Further a command is issued to the device associated with the microscope to move the device associated with the microscope to a new position during the identified period of time.

An image acquisition system for synchronizing movement of a device associated with a microscope and acquisition of images from a camera is associated with the microscope. The image acquisition system includes a camera controller, a system controller, an image acquisition module, and a movement controller. The camera controller receives an exposure signal from the camera associated with the microscope. The system controller analyzes the exposure signal to identify a period of time when the device associated with the microscope may be moved. The image acquisition module receives image data associated with the exposure signal. The movement controller issues a command to the device associated with the microscope to move the device associated with the microscope to a new position during the identified period of time.

Other aspects and advantages of the present invention will become apparent upon consideration of the following detailed description.

### BRIEF DESCRIPTION OF THE DRAWINGS

FIG. 1 is a system diagram of a system to control acquisition of images by a camera of an automated microscope;

FIG. 2 is an exemplary timing diagram of exposure of a sensor in a camera that may controlled by the system of FIG. 1;

FIGS. 3-5 are flowcharts of processing undertaken by the system of FIG. 1 to synchronize operation of a camera and movement of devices of the automated microscope; and

FIGS. 6A-6F are dialog boxes that are generated by a user interface of the system of FIG. 1 to obtain information from an operator thereof.

### DETAILED DESCRIPTION

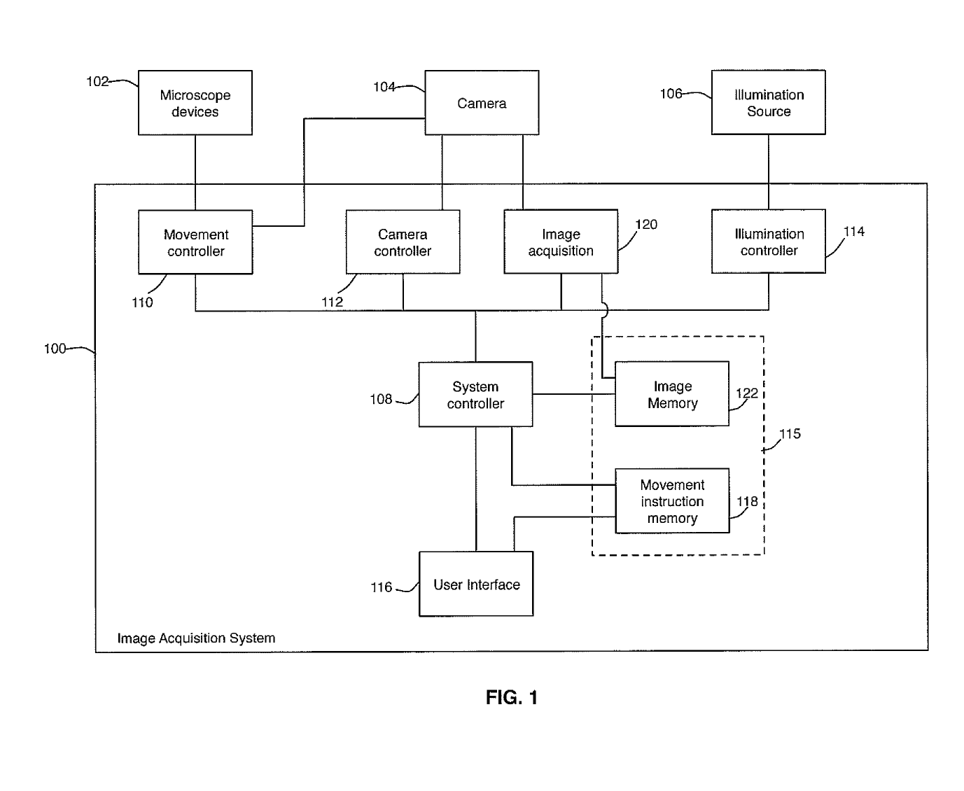

Referring to FIG. 1, an image acquisition system 100 controls microscope devices 102 including a camera 104 and an illumination source 106. The image acquisition system 100 includes a system controller 108, a movement controller 110, a camera controller 112, and an illumination controller 114, and a system memory 115. An operator uses a user interface 116 of the image acquisition system 100 to enter commands that direct the image acquisition system 100 to control the capture of one or more images of sample(s) disposed on the stage of the microscope. Such commands are stored in a movement instruction memory 118, which is a portion of the system memory 115.

As is described above, for each instruction stored in the movement instruction memory, the system controller 108 directs the movement controller 110 to position the microscope devices 102 as specified by the instruction. Thereafter, the system controller 108 directs the camera controller 112 to direct the camera 104 to start an exposure cycle and the illumination controller 114 to turn on the illumination source 106. In some embodiments, the system controller 108 waits to receive a signal from the camera 104 and, in response, directs the illumination controller 114 to turn on the illumination source 106. An image acquisition module 120 of the image acquisition system 100 receives an image frame transmitted by the camera 104 and stores the received image frame in an image memory 122 portion of the system memory 115. Such image frames may then be made available to the operator by the user interface 116 or transmitted to another system (not shown) for analysis.

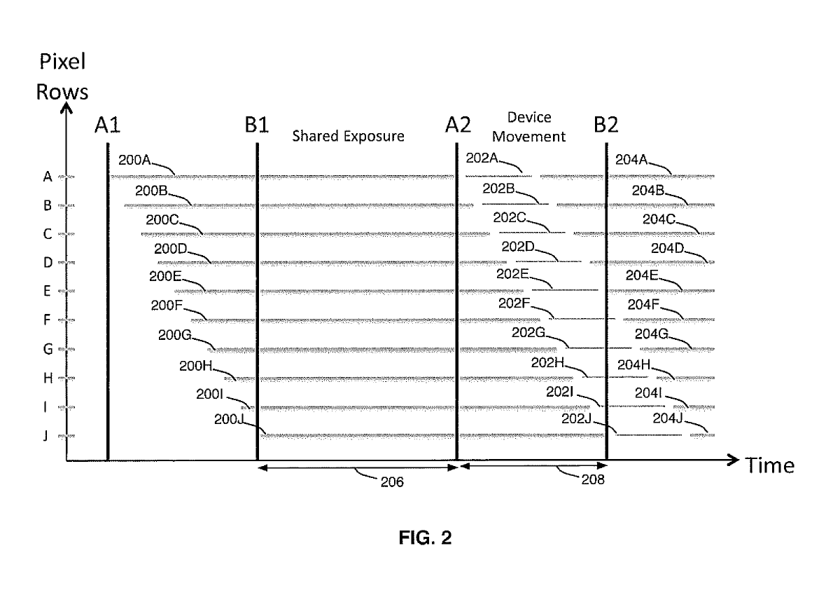

As noted above, if the camera 104 employs a rolling shutter, exposure of the different lines of the sensor of such camera 104 begin at different times. Referring to FIG. 2, a pixel row A of the camera 104 has a first period of time 200A during which the pixels of such row integrate light that reaches such pixel. Thereafter, there is a second period of time 202A when the pixels of pixel rows A do not integrate any additional light. Typically, during such second period 202A, data is read from each pixel that comprises the pixel row A and transferred to the image acquisition system 100 and such pixels are reset. Such data represents one row of pixels of an image frame. The pixels of the row A are thereafter reset, also during the period of time 202A.

After the period of time 202A expires, the pixels of pixel row A begin integrating light during a period 204A for the next image frame captured by the camera 104.

The pixels of rows B through J are similarly exposed during the time periods 200B through 200J, respectively. The pixels of the rows B through I are thereafter read from and reset during time periods 202B through 202J, respectively, in preparation for another exposure during the time periods 204B through 204J, respectively. As shown in FIG. 2, the time when each exposure period 200A through 200J begins is different for each row A through J, respectively. The rolling shutter of the camera 104 staggers the time when exposure of each row begins. Also, each row has window of time during which such row is exposed.

In one embodiment of the camera 104, there is a time period 206 (a “shared exposure period”) during which the time periods 200A through 200J overlap. As shown in FIG. 2, such time period 206 starts when the latest of the periods 200A through 2003 begins and ends when the earliest of the periods 200A through 200J expires.

In an exemplary embodiment, the camera 104 may generate a signal to the camera controller 112 when the exposure of the first one of the rows A through J begins. In the exemplary timing diagram of FIG. 2, such signal is illustrated as occurring at a time A1. Such cameras 104 may also generate a signal, shown in FIG. 2 as occurring at a time B1, when the exposure of the last of the rows A through J begins. The camera 104 may generate a further signal, designated as occurring at a time A2, when the exposure period begun at time A1 ends. Finally, the camera 104 may generate a signal, designated as occurring at time B2, when the exposure period begun at time B1 ends. As illustrated in FIG. 2, a shared exposure period of time 206 between the signals generated at the times designated as B1 and A2 is when rolling shutter of the camera simultaneously exposed all of the rows A through J of the camera 104.

The system controller 108 monitors the signals received by the camera controller 112. In one embodiment, when the system controller 108 detects the signal associated with the start of the shared exposure period 206, the system controller 108 directs the illumination controller 114 to turn on the illumination source 106. When the system controller 108 detects the end of shared exposure period 206, the system controller 108 directs the illumination controller 114 to turn off the illumination source 106. The system controller 108 checks the movement instruction memory 118 to determine if another frame is to be captured and, if so, directs the movement controller 110 to reposition any microscope devices 102 and/or the camera 104 accordingly. The movement controller 110 issues commands to such devices 102,104 after the end of the shared exposure period 206. In one embodiment, the devices 102,104 are repositioned asynchronously in response to such commands during a time period 208 that is between the end of the shared exposure period and the end of the period 200J during which the last of the pixel rows A through J is exposed. In other embodiments, the devices 102,104 are repositioned asynchronously in response to the commands after the end of the shared exposure period and before the beginning of the next shared exposure period, for example, the beginning of the time period 204J of FIG. 2. In still other embodiments, one or more of the microscope devices 102,104 may send a signal to the movement controller 110 that indicate that the such devices are starting to move to a new position and/or that such devices have completed moving to the new position.

After the end of the shared exposure period 206, the camera 104 reads integrated illumination levels of the pixels of the rows A through J and transmits data representing such levels to the image acquisition module 120. It should be apparent to one having skill in the art that the camera 104 may transmit the pixel data as a raw stream of bytes, in compressed or uncompressed form, and encoded in image formats known in the art (e.g., TIFF, JPEG, etc.). It should also be apparent that the image acquisition module 120 may convert the data transmitted by the camera into other formats. After receiving the data, the image acquisition module 120 formats such data into an image frame, if necessary, and stores such frame in the image memory 122.

Some embodiments of the camera 104 may not generate the signals that identify a shared exposure period. Such cameras may provide some of the signals described above. Even when used with such cameras, the system controller 108 synchronizes the movement controller 110, the camera 104, and the illumination source 106 so that microscope devices 102,104 are not repositioned during a period when the sensors of the camera 104 are being exposed.

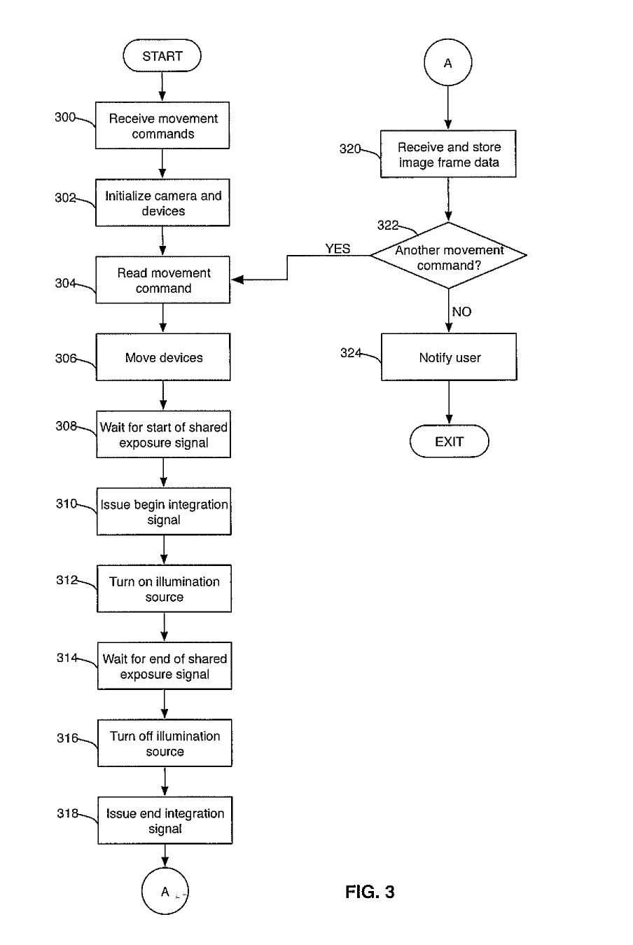

FIG. 3 is a flowchart that illustrates processing undertaken by the image acquisition system 100 when used with a camera 104 that provides signals that identify the shared exposure period 206. Referring to FIG. 3, the user interface 116, at step 300, receives from the user movement commands that indicate images of one or more samples that are to be acquired and stores such movement commands in the movement instructions memory 118. At step 302, the movement controller 110 initializes the microscope devices 102 by, for example, providing power to such devices 102, establishing communications with such devices 102, confirming that the devices 102 are operational, and the like. Also at step 302, the camera controller 112 initializes the camera 104 by, for example, providing power to the camera 102, establishing communications with the camera 104, directing the 104 camera to reset the pixels of rows that comprise the sensor thereof, setting imaging parameters and the like. Typical image parameters may include exposure time, binning (how sensor pixels are combined to produce an image pixel), a region of interest, number of images to acquire, gain, triggering signals to synchronize the camera 104 with other hardware not controlled by the image acquisition system 100, and the like. In addition, the illumination controller 114 turns off the illumination source 106, also at step 302, for example, by turning off power provided to the illumination source 106 or sending a signal to another controller associated with such illumination source 106.

At step 304, the system controller 108 reads a movement instruction from the movement instruction memory 118. At step 306, the movement controller 110 sends commands to one or more microscope devices 102 to move such devices 102 to a position in accordance with the movement instruction. Typically, in response to such commands, the microscope devices 102 move asynchronously with respect to the image acquisition system 100.

At step 308, the camera controller 112 waits for a signal that indicates that start of the shared exposure period 206. At step 310, if supported by the camera 104, the camera controller 112 signals the camera 104 to begin integrating any light that reaches the sensor thereof. Note that because the illumination source 106 was turned off at step 302, no signal may be reaching the sensor.

The illumination controller 114, at step 312, turns on the illumination source 106. Thereafter, at step 314, the camera controller 112 waits for the signal that indicates the end of the shared exposure period 206.

After the signal indicating the end of the shared exposure period 206 is received, the illumination control 114 turns off the illumination source 106. At step 318, if supported by the camera 104, the camera controller 112 issues a signal to the camera 104 to end integration of light on the sensors. At step 320, the image acquisition module 120 receives from the camera 304 data associated with the image frame captured during the shared exposure period 206 and stores such data in the image memory 122. In some embodiments, if necessary, the image acquisition module 120 may signal the camera 104 to initiate transfer of the data. In other embodiments, the camera 104 may automatically begin transferring the data in response to the end integration signal. It should be apparent to those who have skill in the art the different mechanisms may be used by the image acquisition module 120 to obtain data from the camera 104.

At step 322, the system controller 108 checks if there is another movement command in the movement instruction memory 118 that has not been processed. If so, processing returns to step 304. Otherwise, the user interface 116 notifies the user that image capture is complete, at step 324, and exits.

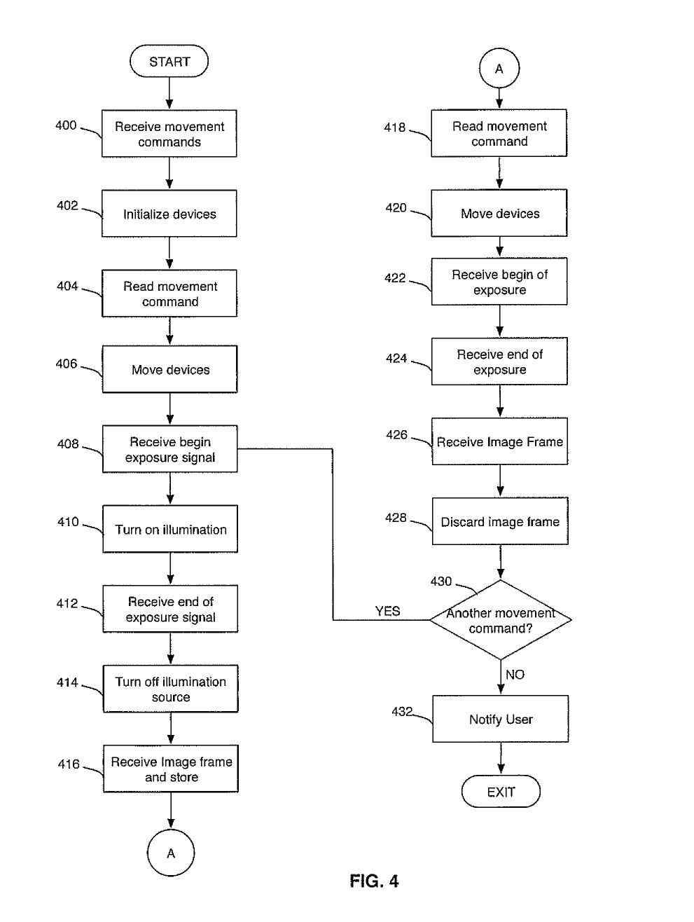

FIG. 4 is a flowchart that illustrates processing undertaken by an embodiment of the image acquisition system 100 when used with a camera 104 that does not provide signals that identify beginning and end of the shared exposure period 206. Referring to FIG. 4, at step 400, the user interface 116 receives from the user movement commands that indicate images of one or more samples that are to be acquired and stores such movement commands in the movement instructions memory 118. At step 402, the movement controller 110 initializes the microscope devices 102, the camera controller 112 initializes the camera 104, and the illumination controller 114 initializes the illumination source 106. If necessary, the illumination controller 114 turns off the illumination source 106.

At step 404, the system controller 108 reads a movement instruction from the movement instruction memory 118. At step 406, the movement controller 110 sends commands to one or more microscope devices 102 to move such devices 102 to a position in accordance with the movement instruction. At step 408, camera controller 112 waits to receive from the camera 104 a signal that indicates that an exposure of one or more rows of the sensor of the camera 104 has started. At step 410, the illumination controller 114 turns on the illumination source 106. At step 412 the camera controller 112 waits until a signal indicating that the exposure of the rows of the sensor of the camera 104 has ended. At step 414, the illumination controller 114 turns off the illumination source. At step 416, the image acquisition module 120 receives from the camera 104 an image frame and stores such image frame in the image memory 122.

At step 418, the system controller 108 reads another movement command, if any, from the movement command memory 118. At step 420 the movement controller 110 repositions the microscope devices 102 and/or the camera 104 in accordance with the movement command read at step 418. Thereafter, at step 422, the camera controller 112 waits until a signal indicating the start of further exposure is received and a step 424 waits until a signal indicating the end of the further exposure is received. At step 426, the image acquisition module 120 receives an image frame from the camera 104 and, at step 428, discards the received frame. The image that results from the exposure of the sensors between steps 424 and 426 is discarded because, during this time period, the microscope devices 102 and/or the camera 104 may still be moving in response to the movement initiated at step 420.

At step 430, the system controller 108 checks if a movement command was read at step 418 and, if so, processing returns to step 408. Otherwise, user interface 116 notifies the user that image acquisition is complete and the image acquisition system 100 exits.

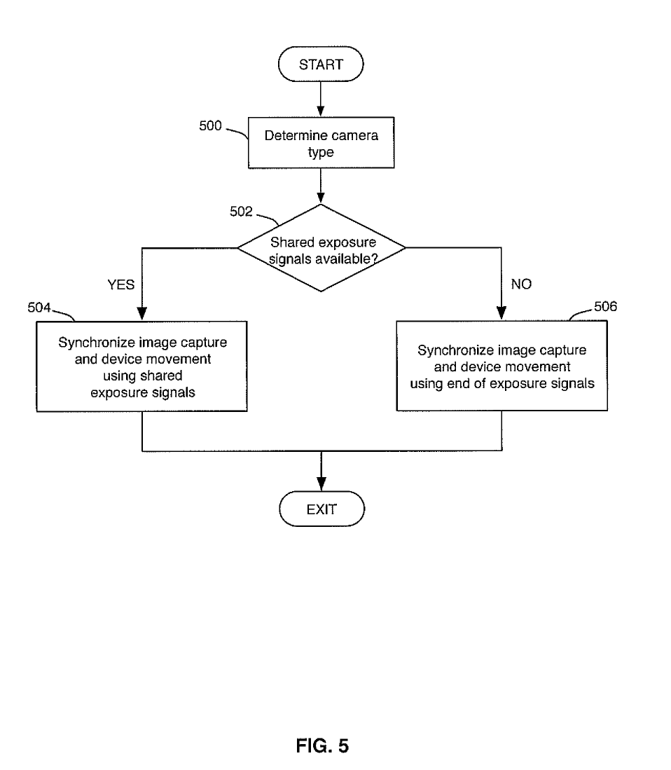

FIG. 5 is a flowchart that illustrates processing undertaken by an exemplary embodiment of the image acquisition system that may be used with different of cameras 104. At step 500, the system controller 108 obtains information about the camera 104 being used. Such information may include the manufacturer and/or model of the camera. In some embodiments, the camera controller 112 may query the camera 104 for such information. In other embodiments, the user interface 116 may obtain such information from the operator. In still other embodiments, such information may be preconfigured in the image acquisition system 100.

At step 502, the system controller 108 checks information regarding the camera 104 to determine if such camera 104 has a capability of providing signals that identify the shared exposure period. In some embodiments, the image acquisition system 100 has stored in a memory thereof a table that indicates the capabilities of various models of cameras 104. In other embodiments, the user interface 116 may ask the user regarding such capability. In still other embodiments, the camera controller 116 may obtain information regarding such capability by querying the camera 104. If the camera 108 does provide signals that identify the shared exposure period processing proceeds to step 504, otherwise processing proceeds to step 506.

At step 504, the image acquisition system 100 undertakes the processing described herein with respect to FIG. 3. At step 506, the image acquisition system 100 undertakes the processing described herein with respect to FIG. 4. After the step 504 or 506, the image acquisition system 100 exits.

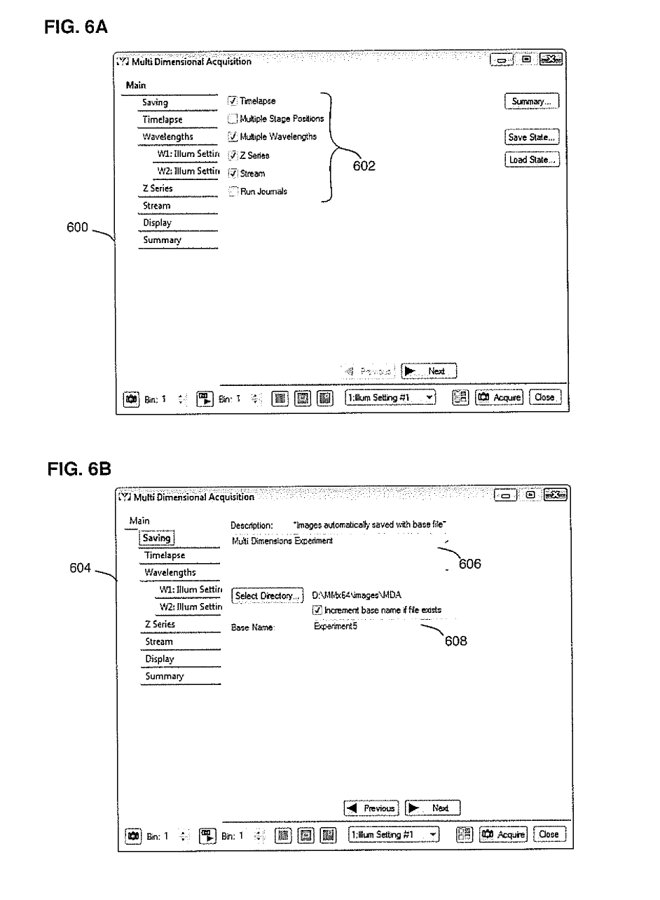

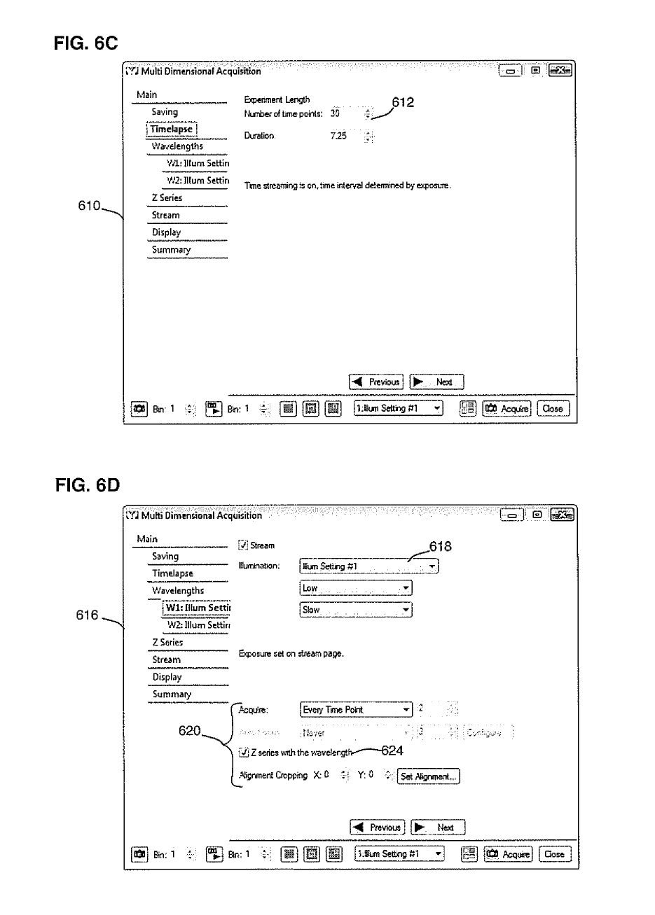

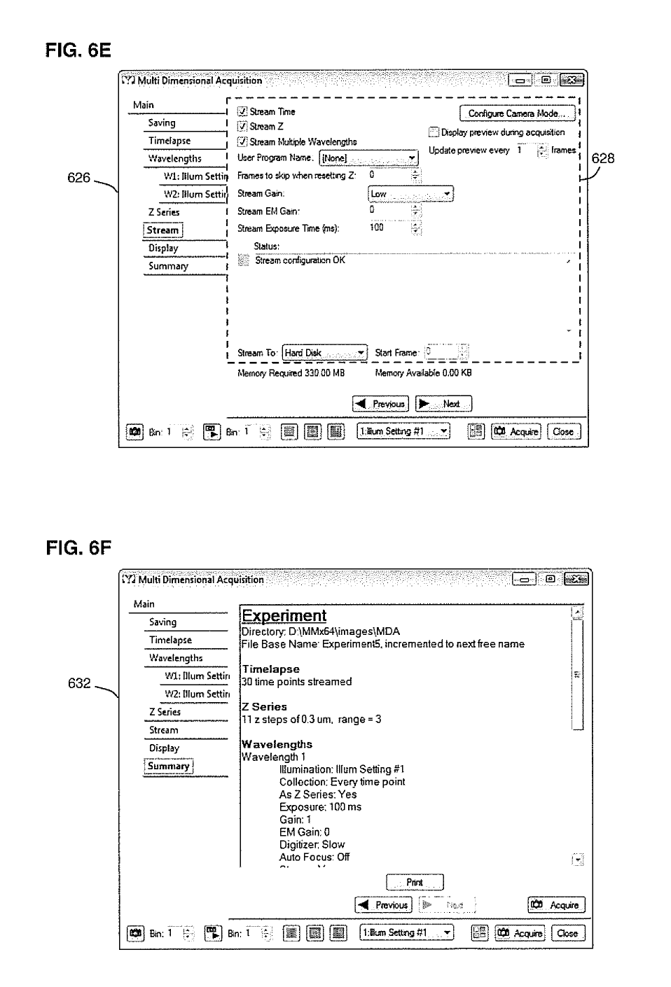

Referring to FIGS. 6A through 6D, the user interface 116 may provide various dialog boxes on a display associated with the image acquisition system 100 to allow the operator to specify movement commands. One dialog box 600 allows the operator to select one or more checkboxes 602 that specify the types of movements the microscope devices 102 are to undertake and the types of images that are to be acquired. In one embodiment, the operator may specify, for example, timelapse series images be acquired, at varying stage positions, using multiple wavelengths of light generated by the illumination device 106, at varying focal planes (Z distances from the sample), as a stream of images (i.e., image frames without a time interval or delay therebetween), and the like.

Another dialog box 604, FIG. 6B, includes a field 606 in which the operator enters a description associated with the images being acquired. The operator, in the dialog box 604, may enter in a field 608 a portion of a file name that is associated with the images. For example, if the operator enters the string “Experiment5” in the field 608, the files of the acquired images may be named “Experiment5_{—}a,” “Experiment5_{—}b,” and so on. A dialog box 610, FIG. 6C, allows the operator to specify acquisition of images at particular intervals. The operator may specify a quantity of image sets in a field 612.

A dialog box 616, FIG. 6D, allows the operator to specify varying illuminations which may involve moving the illumination source or moving filters and other optical elements. For example, the operator may use the pop-up menu 618 to specify a preconfigured illumination setting further options using the dialog elements provided in the area 620. For example, the operator may select a checkbox 624 to specify that the focal plane should be varied between images.

Referring to FIG. 6E, the user interface 116 displays, for example, a dialog box 626 that includes a region 628. The region 628 includes checkboxes, popup menus, and fields the user can modify to specify parameters associated with streaming images from the camera 104.

Referring to FIG. 6F, the human interface 116 displays, for example, a dialog box 632 to report to the operator the imaging sequence that is about to be acquired.

The acquisition system 100 described above allows for rapid acquisition and streaming of images from a camera of an automated microscope. Such acquisition and streaming is accomplished while minimizing the possibility of introducing artifacts in such images due to movement of microscope devices. Some applications of the system described herein include fast acquisition of 3D images of a sample, fast acquisition of multiple fluorophore labeled samples over time, and acquisition of 3D and multiple fluorophore labeled samples over time. Other applications will be apparent to those who have skill in the art.

It will be understood and appreciated that one or more of the processes, sub-processes, and process steps described in connection with FIGS. 1-6 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules schematically depicted in FIGS. 1-6. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the system controller 108, movement controller 110, camera controller 112, illumination controller 114, the user interface 116, and image acquisition module 120 of FIG. 1), which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system, direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that receiving and transmitting of signals as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A computer-implemented method of synchronizing movement of a device associated with a microscope and acquisition of images from a camera associated with the microscope, comprising:
receiving an exposure signal from the camera associated with the microscope;
analyzing the exposure signal to identify a period of time when the device associated with the microscope may be moved;
receiving image data associated with the exposure signal; and
issuing a command to the device associated with the microscope to move the device to a new position during the identified period of time.

2. The computer-implemented method of claim 1, wherein the camera associated with the microscope uses a rolling shutter.

3. The computer-implemented method of claim 1, wherein issuing the command further comprises issuing a command to move to a new position at least one of an X-Y stage of such microscope, a camera mount, a camera, a flash unit, a focusing device, a filter, a phase ring, and a dichromatic mirror.

4. The computer-implemented method of claim 1, further comprising:
analyzing the exposure signal to determine that the received data should be stored; and
storing an image frame in accordance with the received data in accordance with such determination.

5. The computer-implemented method of claim 1, wherein receiving the exposure signal further comprises receiving an exposure signal that indicates the end of a shared exposure period and issuing the command is undertaken in response to such signal.

6. The computer-implemented method of claim 5, wherein the received data is associated with light integrated during the shared exposure period by a sensor of the camera associated with the microscope.

7. The computer-implemented method of claim 5, further comprising:
receiving a further exposure signal that indicates the start of a further shared exposure period; and
issuing a signal to turn on an illumination source in response to such signal.

8. The computer implemented method of claim 7, further comprising:
receiving a still further exposure signal that indicates the end of the further shared exposure period;
issuing a signal to turn off the illumination source in response to the still further exposure signal;
receiving further image data associated with light integrated during the further shared exposure period by the sensor of the camera associated with the microscope; and
storing the further data.

9. The computer-implemented method of claim 1, wherein receiving the exposure signal comprises receiving a signal that indicates an exposure period has ended, and receiving the image data comprises receiving image data associated with light integrated during the exposure period by a sensor of the camera associated with the microscope.

10. The computer-implemented method of claim 9, further comprising:
receiving a further exposure signal from the camera that a further exposure period has ended;
receiving further image data associated with light integrated during the further exposure period by the sensor of the camera associated with the microscope;
storing an image frame in accordance with the image data associated with light integrated during the exposure period; and
discarding the further image data associated with light integrated during the further shared exposure period.

11. The computer-implemented method of claim 1, further comprising moving the microscope device asynchronously in accordance with the issued command, wherein receiving image data and the moving the microscope device asynchronously are undertaken simultaneously.

12. The computer-implemented method of claim 1, wherein the issued command is in accordance with a movement instruction selected from a plurality of movement instructions provided to a user interface.

13. An image acquisition system for synchronizing movement of a device associated with a microscope and acquisition of images from a camera associated with the microscope, comprising:
a camera controller that receives an exposure signal from the camera associated with the microscope;
a system controller that analyzes the exposure signal to identify a period of time when the device associated with the microscope may be moved;
an image acquisition module that receives image data associated with the exposure signal; and
a movement controller that issues a command to the device associated with the microscope to move device associated with the microscope to a new position during the identified period of time.

14. The image acquisition system of claim 13, wherein the camera associated with the microscope uses a rolling shutter.

15. The image acquisition system of claim 14, wherein the command issued by the movement controller directs at least one of an X-Y stage of such microscope, a camera mount, a camera, a flash unit, a focusing device, a filter, a phase ring, and a dichromatic mirror to move to a new position.

16. The image acquisition system of claim 13, wherein the system controller analyzes the exposure signal to determine that the received data should be stored and the image acquisition module stores an image frame in accordance with the received data in accordance with such determination.

17. The image acquisition system of claim 13, wherein:
the exposure signal received by the camera controller comprises an exposure signal that indicates the end of a shared exposure period and the movement controller issues the command in response to such signal;
the image data received by the image acquisition module is associated with light integrated during the shared exposure period by a sensor of the camera associated with the microscope; and
further comprising an illumination controller, wherein the camera controller receives a further exposure signal that indicates the start of a further shared exposure period and the illumination controller issues a signal to turn on an illumination source in response to such signal.

18. The image acquisition system of claim 17, wherein:
the camera controller receives a still further exposure signal that indicates the end of the further shared exposure period;
the illumination controller issues a signal to turn off the illumination source in response to the still further exposure signal; and
the image acquisition module receives and stores further image data associated with light integrated during the further shared exposure period by the sensor of the camera associated with the microscope.

19. The image acquisition system of claim 13, wherein the microscope device moves asynchronously in accordance with the issued command and wherein the image capture device receives image data simultaneously as the microscope device moves asynchronously.

20. The image acquisition system of claim 13, further comprising a user interface for receiving a plurality of movement instructions and wherein the issued command is in accordance with a movement instruction selected from the plurality of movement instructions.
